(19) United States
(12) Patent Application Publication
(10) Pub. No.: US 2013/0226369 A1
(43) Pub. Date: Aug. 29, 2013

(54) PORTABLE VEHICLE TELEMATICS SYSTEMS AND METHODS

(71) Applicant: Sirius XM Radio, Inc., (US)

(72) Inventors: Rudy YORIO, Pompano Beach, FL (US); Paul MARKO, Pembroke Pines, FL (US); Craig WADIN, Sunrise, FL (US); Stelios PATSIOKAS, Coral Springs, FL (US); Paul KELLEY, Deerfield Beach, FL (US)

(73) Assignee: Sirius XM Radio, Inc., New York, NY (US)

(21) Appl. No.: 13/776,539

(22) Filed: Feb. 25, 2013

Related U.S. Application Data
(60) Provisional application No. 61/602,557, filed on Feb. 23, 2012.

(51) Int. Cl. G06F 17/00

(52) U.S. Cl. CPC G06F 17/00
USPC 701/1

(57) ABSTRACT

A portable sensing and telematics device senses one or more conditions with respect to a vehicle and/or its occupant(s) and can communicate regarding, or in response to, the sensed condition to a remote entity (e.g., emergency responders, law enforcement agencies, other entities that monitor vehicle occupants or usage). An exemplary device can be integrated in, for example, a cigarette lighter adapter (CLA) configured to be connected to a vehicle cigarette lighter socket or auxiliary power socket. The portable sensing and telematics device can be connected to a tethered smartphone, interface with an in-vehicle modem or cellular phone, or incorporate smartphone or similar functionality within. Other form factors are possible. An exemplary device can be used in a wide variety of emergency sensing and response applications, as well as various monitoring applications and scenarios.

### CROSS-REFERENCE TO RELATED APPLICATIONS

This application claims the benefit of U.S. Provisional Patent Application No. 61/602,557, entitled SYSTEM AND METHOD OF PORTABLE VEHICLE OCCUPANT CONDITION SENSING AND TELEMATICS COMMUNICATIONS, filed on Feb. 23, 2012, and PCT/US2012/068318, filed on Dec. 6, 2012, the disclosure of each of which is hereby fully incorporated by reference. Related subject matter is disclosed and claimed in commonly owned US 2011/0045794, entitled DOCKING UNIT AND VEHICLE POWER ADAPTER WITH FREQUENCY MODULATED AUDIO SIGNAL INJECTION FOR CONNECTING PORTABLE MEDIA PLAYER AND/OR COMMUNICATIONS DEVICE TO VEHICLE FM RADIO AND AUDIO SYSTEM FOR PLAYBACK OF DIGITAL AUDIO BROADCAST STREAM (the “Docking Unit Application”), the entire contents of which is also hereby incorporated by reference.

### BACKGROUND OF THE INVENTION

Digital music consumption (e.g., the acquisition of selected audio tracks for personal listening enjoyment) continues to increase with advances in digital music products such as on-line music services and devices for digital music storage and playback. In particular, portable media players and personal digital assistants such as the iPod available from Apple, Inc. and personal communication devices (e.g., mobile terminals or cellular telephones) such as the iPhone also available from Apple Inc., which have additional applications such as music download and playback applications, are becoming increasingly popular.

Existing download sources are not as comprehensive as, for example, the music library of a satellite digital audio radio service (SDARS) such as, for example, that of Sirius XM Radio Inc. For example, some download sources only provide users access to recordings of one or more particular recording companies. Furthermore, one of the primary drivers for consumption of new music and other media is exposure to new content through spontaneous programmed broadcast content such as FM radio, television, and satellite radio. In particular, exposure to a rich variety of content provided by a broadcast programmer can be a powerful motivator to gain interest in, investigate and ultimately acquire new music and other media.

The Docking Unit Application, referenced above, addresses just such a need by describing various embodiments of a novel and simple device that can interface digital media players such as the iPod, iPhone, smartphones, tablets, Android based machines, and the like with a SDARS or similar programming service. As disclosed in the Docking Unit Application, this can optimally be accomplished in a vehicle using an existing vehicle FM radio system. The Docking Unit Application also discloses an application program that can be downloaded to a digital media player, personal electronic device or smartphone to facilitate the selection, storage and playback, and optionally, the acquisition, of content from a SDARS or similar programming service, using the digital device's user interface.

Telematics generally refers to solutions that are based on information flowing to and/or from a vehicle. For example, vehicle telematics can refer to automobile systems that combine Global Positioning System (GPS) tracking and other wireless communications for automatic roadside assistance and remote diagnostics. When implemented, telematics have the potential to increase operational efficiency and improve driver safety in a number of ways. For example, GPS technology can be used to track a vehicle's location, mileage, and speed. Communications technology promotes connectivity between drivers and other parties such as service dispatchers (e.g., public safety answering point or PSAP, traffic data aggregator, commercial telematics service providers or call centers such as Onstar Corporation, and the like). Sensors monitor vehicle operations and conditions which can then be used to streamline vehicle maintenance, or facilitate seeking assistance for the vehicle occupants. For example, accelerometers measure changes in speed and direction, and cameras can monitor road conditions, and drivers' actions.

In addition to interfacing media players with a vehicle's SDARS receiver and head unit, there also exists a need in-vehicle for interfacing various telematics functionalities with existing in-vehicle resources, such as, for example, an SDARS head unit, a communications device or interface, such as an in-vehicle modem or cellular telephone, or, for example, a smart phone, tablet or other portable device with the ability to store and run various telematics applications or telematics control applications such as emergency assistance, and traffic monitoring, data aggregation and reporting.

### SUMMARY OF THE INVENTION

In exemplary embodiments of the present invention, a portable sensing and telematics device can sense one or more conditions with respect to a vehicle and/or its occupant(s), and can communicate information about, or in response to, the sensed condition to a remote entity, such as emergency responders, law enforcement agencies, or various monitoring services and systems that track or monitor vehicle occupants or their activities. For example, the portable sensing and telematics device can be connected to, or integrated in, a cigarette lighter adapter (CLA) configured to be connected to a vehicle cigarette lighter socket or auxiliary power socket. The CLA can convert DC power from the vehicle to supply its components as well as other device(s) connected to the CLA. The portable sensing and telematics device can be connected to a tethered smartphone or other personal electronic device, can interface with an in-vehicle modem or cellular phone, or can itself incorporate smartphone or similar functionalities within it. Other small footprint form factors are possible. An exemplary device can be used in a wide variety of emergency sensing and response applications, as well as various monitoring applications and scenarios.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram of an exemplary portable sensing and communications device connected to a smartphone according to an exemplary embodiment of the present invention;

FIG. 2A depicts a stand alone portable telematics device with a simplified user interface according to an exemplary embodiment of the present invention;

FIG. 2B depicts a portable telematics device connected to a mobile terminal, which itself is connected to a vehicle head unit according to an exemplary embodiment of the present invention;

FIG. 2C depicts the portable telematics device of FIG. 2B enhanced to receive analog audio and play same through the vehicle head unit according to an alternate exemplary embodiment of the present invention;

FIG. 2D depicts the portable telematics device of FIG. 2C further enhanced to receive an SDARS signal and play same through the vehicle head unit according to another alternate exemplary embodiment of the present invention; and

FIG. 3 is a block diagram of an exemplary portable vehicle and/or occupant(s) sensing and telematics device in accordance with an illustrative embodiment of the present invention.

It is noted that throughout the figures, the same drawing reference numerals will be understood to refer to the same elements, features, and structures;

### DETAILED DESCRIPTION OF THE INVENTION

Next described are various exemplary portable telematics systems and devices that can be provided in a vehicle. Some of these exemplary devices are based on the CLA device described in the Docking Unit Application, others can have different form factors, but similar low footprint in-vehicle access. Exemplary systems can stand alone, or, for example, can interoperate with a smartphone, and/or be integrated with an existing SDARS receiver and head unit already in the vehicle.

Thus, in exemplary embodiments of the present invention, a low footprint portable telematics device can be provided in a vehicle. Such a device can provide easy access to a user with no or minimal disruption of his or her field of view or range of motion within the vehicle cabin. The device can include, for example, (i) one or more sensors for detecting one or more conditions of a vehicle and/or its occupant(s), and (ii) a communications interface for communicating with a remote monitoring system and/or responder in response to any detected condition(s). For example, such a portable device can be provided in a Cigarette Lighter Adaptor (CLA), as described in the Docking Unit Application, and can be coupled with a smartphone or other suitable mobile terminal so as to enable crash detection. Exemplary mobile terminals can include, for example, an iPad™, iPhone, Android based device, smartphone, tablet, etc. The CLA can comprise a crash detection accelerometer or other sensors, and can include either a wired connection USB charger or, for example, a wireless link, such as, for example, Bluetooth™ (“BT”) 802.11, or the like, to the smartphone or other mobile terminal. Upon sensing a crash, an exemplary software application running on the mobile terminal can initiate a request for emergency help through a telematics response service. In various exemplary embodiments of the present invention, either the CLA, smartphone or other in-vehicle device can provide position sensing, and the smartphone or other coupled device can, for example, (i) transmit the vehicle's location, and (ii) initiate a conversation between a response service and the vehicle's occupants.

It is highly noteworthy that in exemplary embodiments of the present invention at least one accelerometer is provided in the portable telematics device. The accelerometer, preferably an XYZ or 3-axis accelerometer, can be used for crash and other significant event detection. Three axis is preferred because the orientation of the accelerometer will change from car to car as the cigarette lighter sockets are mounted differently. Containing the accelerometer within the CLA increases the reliability of the crash detection, as opposed to trying to leverage an accelerometer provided in a tethered smartphone. In exemplary embodiments of the present invention the accelerometer in the CLA can be a 3-axis (XYZ) accelerometer capable of measuring G forces up to a range of, for example, 15 G or higher, or in other exemplary embodiments, up to 25 G or higher, to insure that the accelerometer reading does not clip during a crash. This is required in order to obtain an accurate delta velocity (ΔV) reading. In addition, when the accelerometer is mounted securely in a Cigarette Lighter socket, the accelerometer can more accurately capture G forces transmitted through the body of the vehicle. In general a smartphone is not guaranteed to be secured to the vehicle, and thus cannot be relied upon to accurately capture the G forces transmitted through the body of the vehicle. Another option, for example, is to use a 2-axis (XY) accelerometer capable of measuring G forces in the range of 15 G or higher, or in the range of 25 G or higher, which is aligned or calibrated based on the installation orientation to measure lateral forces on the vehicle. The calibration is an extra step but it allows the use of a 2-axis accelerometer.

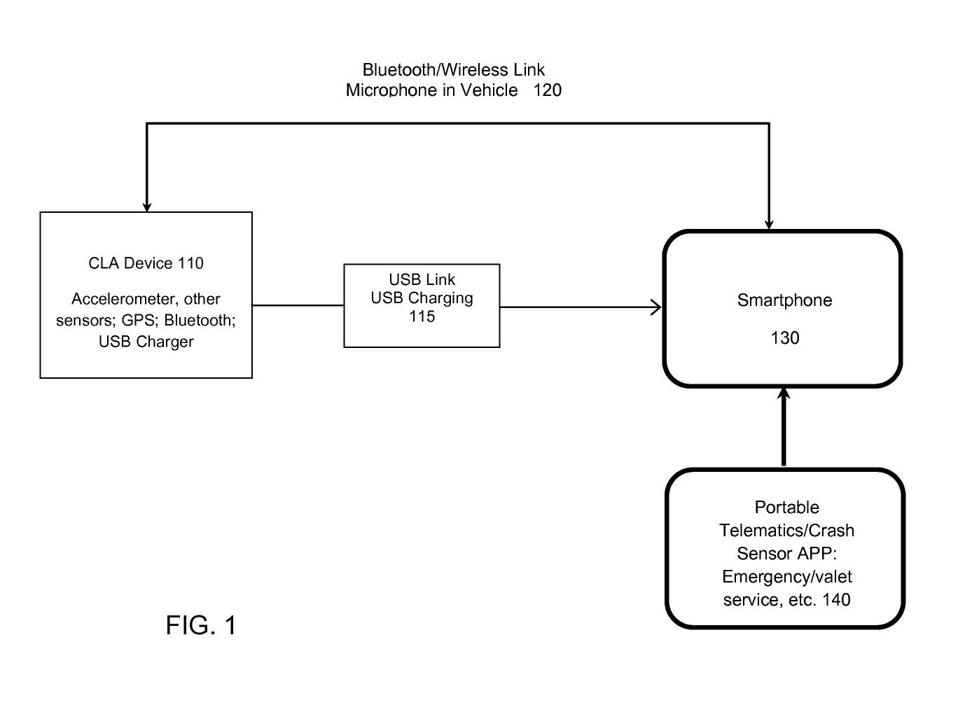

FIG. 1 illustrates an exemplary portable device provided in a CLA form factor and connected to a smartphone. It is understood that a wide variety of small footprint portable telematics devices can be equivalently used, with the same functionality and connectivity, and the CLA form factor is presented as only one possible example. The inventive functionality being to provide a portable telematics device that can draw upon vehicle power and/or have its own power supply, and that has a relatively small footprint, allowing users to add telematics functionality to a vehicle via an aftermarket product. Such a device can either stand alone, or, for example, can connect to a smartphone or equivalent device in various ways. In the former case, the device can have a simple human-machine interface (“HMI”) consisting of, for example, three buttons, as described below. In the latter case, the smartphone or equivalent device can provide the HMI and can run an application that controls the telematics functionality.

Thus, with reference to FIG. 1, portable device 110 can have at least one sensor such as, for example, an accelerometer, vehicle rollover detector, and an air bag deployment sensor, among other crash detection devices. The device's sensors can also include, for example, a spot locator, a personal safety or monitoring device, a driver monitoring device, or other sensing devices for which telematics can be useful.

Continuing with reference to FIG. 1, the exemplary portable device can also include position sensing functionality such as a Global Positioning System (“GPS”) device, or, for example, can receive position information from another device, such as, for example, smartphone 130 or, for example, a separate GPS device provided in the vehicle. The portable device can further include a power converter (not shown) for converting power from a source such as a vehicle battery or a connected power supply, or, for example, can have its own power supply, or for example, can have both. A USB charger 115 can be provided to which smartphone 130 or other equivalent device can be connected for in-vehicle charging. This is most useful inasmuch as consumers generally do not desire to give up a cigarette lighter type charging portal by dedicating it to a device if that entails giving up a charging station. By integrating a charging portal into the exemplary device, a user can have both the device and continue to have the ability to charge a smartphone or other consumer device in the vehicle from the occupied power portal.

Portable device 110 can further include a cell phone module or the like with which to perform telematics communications functions such as (i) initiating a call to a responder, (ii) remote monitoring in response to a detected condition of the vehicle and/or occupant(s), and (iii) session management. It is understood that other wireless communications protocols and links can be employed, of various available types, and that an exemplary telematics responder service can be IP based. Further, portable device 110 can include, for example, a Bluetooth™ or other wireless link 120 for communicating with smartphone 130 or interfacing with a vehicle head unit and speaker system to allow for hands-free operation. Thus, device 110 can be configured, for example, as a portable CLA that can wirelessly communicate with different types of smartphones, portable computers, personal data assistants, thereby essentially providing a universal interface. Finally, smartphone 130 can have a resident telematics/crash sensor application, which takes sensor inputs from CLA device 110, sent across one or both of wireless link 120 or direct link 115, and processes them to take various telematics actions.

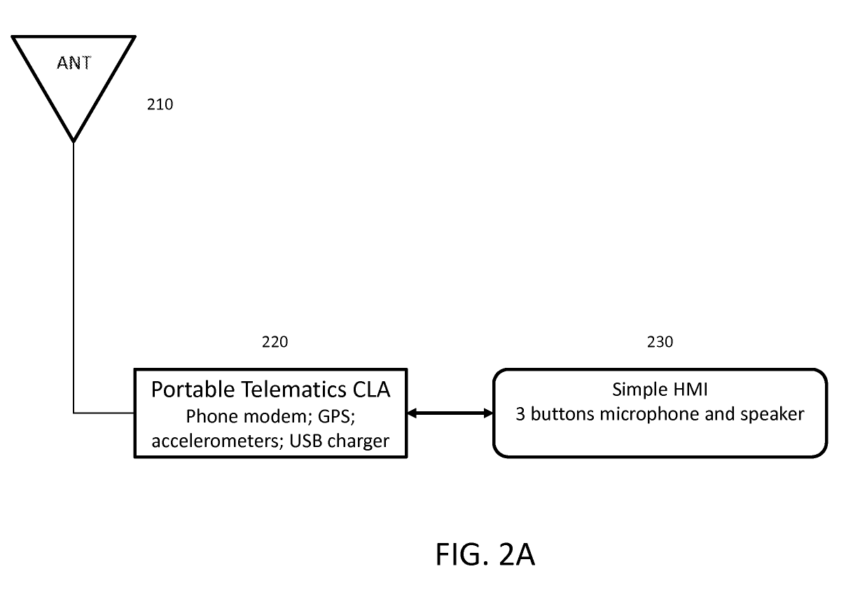

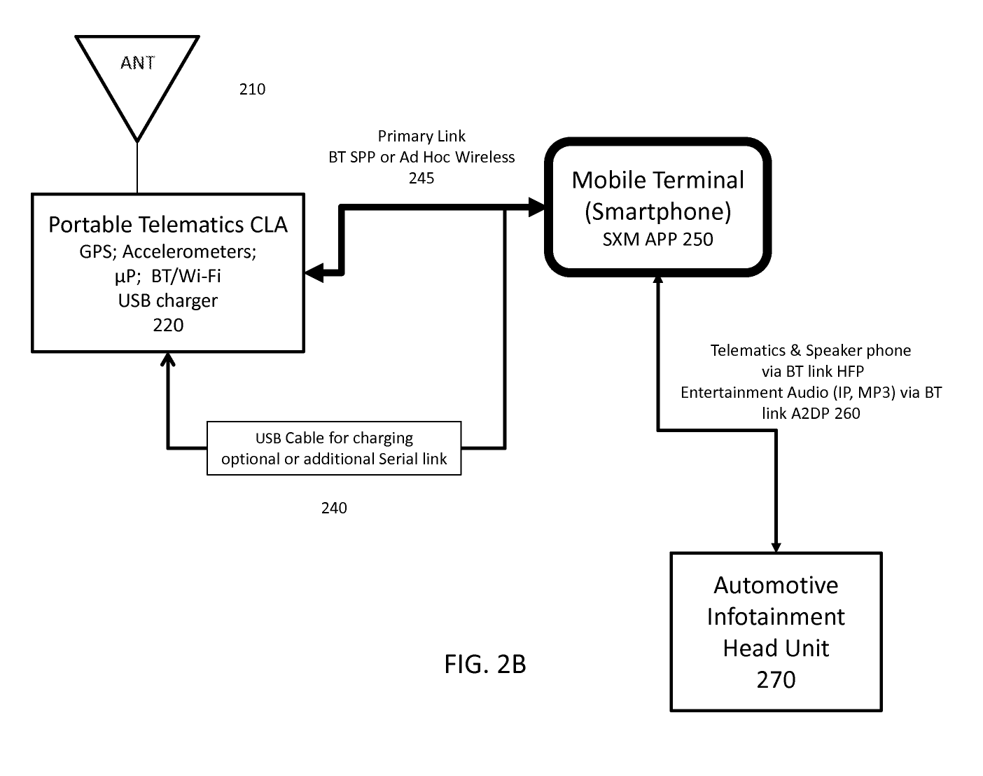

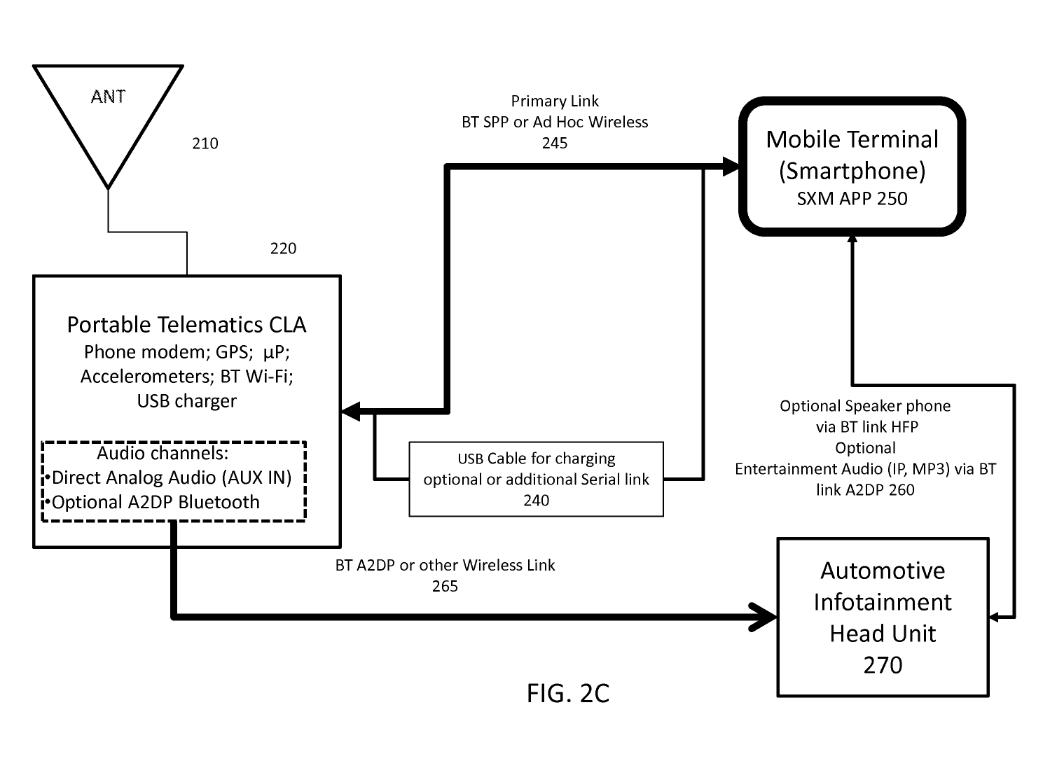

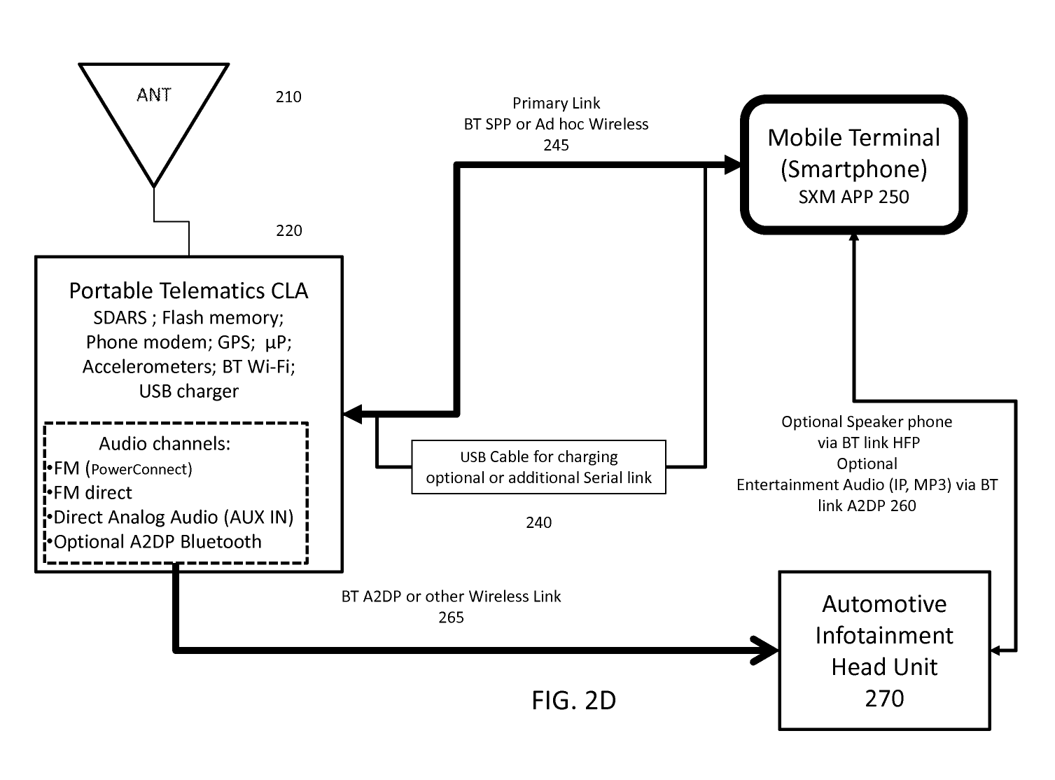

FIGS. 2A-2D, next described, illustrate various exemplary telematics systems utilizing a portable device according to various exemplary embodiments of the present invention.

With reference to FIG. 2A there is shown an antenna 210 which can transmit and receive cellular telephone communications. Antenna 210 is coupled to an exemplary portable telematics CLA device 220, which is provided with an integrated telephone modem and or other communications interface to a responder or monitoring service, GPS functionality and accelerometers or other crash sensors. As shown, device 220 also has a simple integrated HMI, which can consist of, for example, a 3-button user interface provided with a phone button, an agent button, and an emergency or “panic” button, as well as a microphone and speaker. Thus, by means of device 220, a user can initiate a telephone call, contact a telematics service provider agent, or signal an emergency which will trigger a response by emergency responders. It is understood that HMI 230 is integrated within device 220 in the example of FIG. 2A. As noted below, CLA device 220 can access and convert vehicle power, in the manner described in detail in the Docking Unit Application.

FIG. 2B depicts an alternate exemplary embodiment, where device 220 is further enhanced so as to include a microprocessor and a USB charger. In this exemplary embodiment, device 220 is also provided with a Bluetooth, WiFi or other wireless link to a mobile terminal 250, which can be a smartphone, for example. Accordingly, in this exemplary embodiment, no cell phone modem need be provided in device 220, as it can access the cellular network via mobile terminal 250. Of course, the cellular modem shown in FIG. 2A can also be provided in device 220 in the example of FIG. 2B, as an alternate redundant pathway. Thus, in this exemplary embodiment, a smartphone can run an application—shown in FIG. 2B as “SXM APP” which can serve as the HMI and control application for the telematics functionality of portable device 220. The smartphone application can also provide a subscriber portal functionality through which a user can input different preferences and parameters used to interact with telematics service providers, contractors and other agents for services such as those described below. The wireless link can be Bluetooth Serial Port Protocol, (“SPP”) or an ad hoc wireless link, for example.

Additionally, portable device 220 can be physically wired to mobile terminal 250 via a USB cable 240. Such a cable can also be used for charging mobile terminal 250, as described above. Additionally, for example, another serial link can be provided.

Mobile terminal 250 can be wirelessly coupled to automotive infotainment head unit 270, or for example, it could be hard wired to it via a docking mechanism, as is known. Preferably, so as not to require a user to bother with a docking unit for, for example, a smartphone, the link can be Bluetooth hands-free profile (“HFP”), for example, used to transmit telephone and telematics audio to the vehicle speakers and from a vehicle built-in microphone. Additionally, there can be another Bluetooth link between mobile terminal 250 and automotive infotainment head unit 270, this one to transfer entertainment audio, such as for example, IP and MP3 data, this second Bluetooth link being A2DP. As is known, multiple Bluetooth links using different protocols can be simultaneously established.

FIGS. 2C and 2D are very similar to FIG. 2B, except that they each illustrate further enhancements to the exemplary portable telematics CLA device 220. These two figures are next described.

FIG. 2C depicts yet another alternate exemplary embodiment, where device 220 is further enhanced so as to include direct analog audio channels via an auxiliary input “AUX IN.” Thus, auxiliary audio content can also be played through portable device 220 in this exemplary embodiment. In order to play such audio content through the vehicle speakers, an additional Bluetooth link 265, such as via A2DP, can, for example, be provided between portable device 220 and automotive infotainment head unit 270.

Finally, FIG. 2D depicts yet another alternate exemplary embodiment, where device 220 is further enhanced so as to include an SDARS receiver to receive a satellite radio signal. The device 220 of FIG. 2D also includes a phone modem, which can be used in combination with, or separately from cellular communications via mobile terminal 250. Because the device 220 has SDARS capability, it receives an SDARS signal via antenna 210, which is a logical device and can comprise various physical antenna elements. Given the SDARS capability, the device 220 can play the SDARS audio received through automotive infotainment head unit 270, by FM transmission over existing vehicle power connections, as described in the Docking Unit Application, or for example, via the A2DP Bluetooth connection as was described above in connection with FIG. 2C.

It is noted that FIGS. 2A-2D are intended as exemplary configurations, and thus not at all exhaustive. Features of one of FIGS. 2A-2D can also be added to the exemplary systems of others of FIGS. 2A-2D, whenever possible, in various still alternate exemplary embodiments. Thus, in addition to using the mobile terminal 250 for the HMI, a portable device 220 can always be provided with a panic button, or for example, the phone and agent button as well. That way, if it is more convenient to reach down to the portable device (or necessary, if in a crash the mobile terminal is un-accessible) a user can simply control communications via the HMI on device 220.

Given the examples of FIGS. 2A-2D, in various exemplary embodiments of the present invention, the exemplary devices of FIGS. 2A-2D can comprise a CLA with an optional satellite radio or other programming tuner, in addition to having one or more of a crash sensor, USB charger, GPS device, and cell phone module or other communications interface to a responder or monitoring service. The portable device 220 can be provided with one or more antennae 210 for receiving one or more of GPS signals, satellite broadcast programming or other wireless programming, and cellular communications. A tuner, for example, provided in portable device 220 can be controlled, for example, by an application resident on a mobile terminal 250, or the like, to receive a selected programming channel that can be provided to automotive infotainment head unit 270 via, for example, FM modulation, or other connectivity mode, for output via a vehicle speaker system. In addition, content stored in mobile terminal 250 can similarly be provided to head unit 270 via portable device 220, as described above. Thus, wireless link 245 can be provided between mobile terminal 250 and portable device 220 for exchanging tuner control data or other player data, such as, for example, MP3 data, to playback selected content received on portable device and/or stored, on either portable device 220 or mobile terminal 250 via the vehicle speaker system.

In exemplary embodiments of the present invention, speakerphone Bluetooth™ link 260 can be arranged to have priority over content being played back via the vehicle speaker system. It is to be understood, however, that portable device 220 can, in various exemplary embodiments, operate independently of vehicle head unit 270. As noted above, portable device 220 can, for example, be arranged to convert vehicle power so as both to power its components and provide power to other devices. This can be done, for example, via USB charging link 240.

In exemplary embodiments of the present invention, portable device 220 can be configured to sense conditions such as, for example, speed, distance, range from a selected location, use of texting via, or call operations on, a connected smartphone, vehicle crash conditions, and daylight or time conditions, amongst others. Speed can be sensed, for example, using an accelerometer to translate acceleration and deceleration forces in to a change in velocity of the vehicle, as is known in the art. This can be done, for example, using a 3-axis accelerometer in device 220, with a range of 15 G or higher, or, alternatively with a range of 25 G or higher, so as to insure that the accelerometer reading does not clip during a crash. Making sure that the accelerometer reading does not clip during a crash is critical to obtaining an accurate ΔV reading. Alternatively, as noted above, a XY accelerometer capable of measuring G forces in the range of 15 G or higher, or alternatively in the range of 25 G or higher, and which is aligned or calibrated based on the installation orientation to measure lateral forces on the vehicle, can be used. The calibration is an extra step but it allows the use of a 2-axis accelerometer.

In exemplary embodiments of the present invention, in addition to providing emergency response to a detected crash via telematics, an exemplary portable device can be used for various other purposes, such as, for example, monitoring. Such monitoring can include, for example, (i) monitoring drivers on probation due to criminal or traffic violations, (ii) monitoring drivers having restricted licenses due to age, inexperience or disability, and (iii) monitoring of driver behaviors such as drifting or erratic speeds due to inattentiveness (e.g., driver is falling asleep at the wheel, is distracted by texting or other communications activity, etc.).

Thus, in exemplary embodiments of the present invention, an exemplary portable telematics device, with or without a smartphone, can institute two-way communications with a monitoring center or responder. In addition, it can, for example, collect data for use by one or more monitoring entities, such as, for example, a driver's legal guardian, law enforcement, insurance companies, automobile manufacturers, etc.

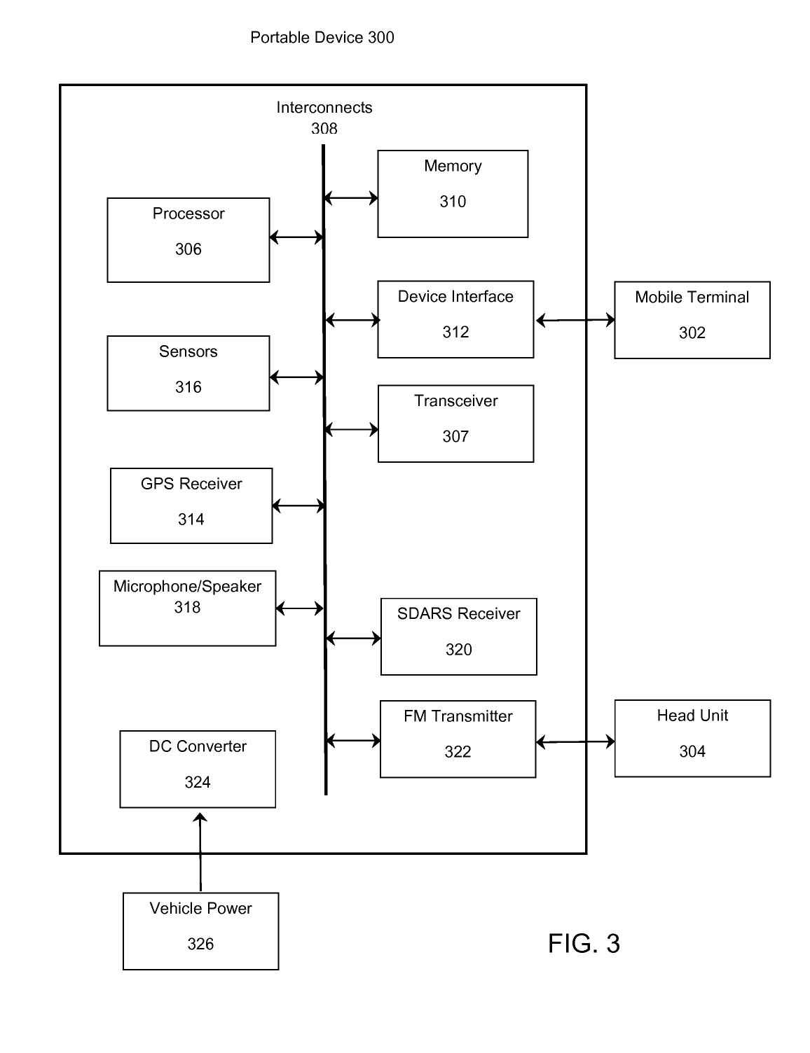

FIG. 3 depicts a block diagram of an exemplary portable device 300, such as, for example, a CLA device of FIG. 2, that can be used to implement an exemplary portable telematics safety and security service as described above, according to various exemplary embodiments of the present invention. In one such example, CLA 300 can be coupled to a mobile terminal 302, such as a smartphone or other user device with communications functionality, and a vehicle head unit 304. As described below, CLA 300 can perform various telematics functionalities itself, or CLA 300 and mobile terminal 302, operating in concert, can, for example, perform these functionalities. Continuing with reference to FIG. 3, CLA 300 can include a processor 306 that can, for example, perform general logic and/or mathematical instructions (e.g., hardware instructions such as RISC, CISC, VLIW, etc.) so as to interface with and/or control devices within CLA 300. For example, processor 306 can perform a telematics control unit (TCU) application, which can be, for example, a mobile telephone operating system application, to implement processes such as those described herein. Alternatively, processor 306 can be arranged to cause mobile terminal 302 to perform the relevant applications and functionalities. Processor 306 can, for example, include internal memory devices such as registers and local caches for efficient processing of instructions and data. Processor 306 can communicate with other hardware within SLA 300, such as, for example, memory 310, via interconnect or backplane 308. Interconnect or backplane 308 can be, for example, a bus, I2C, memory mapped, GCIO, serial, or any combination of these. Memory 310 can, for example, be either a volatile storage medium, such as SRAM, DRAM, etc., or a non-volatile storage medium, such as FLASH, EPROM, or EEPROM, or, for example, any combination of the two. Memory 310 can, for example, be used to store instructions, parameters, and other relevant information for use by processor 306. GPS receiver 314 can receive satellite signals to determine the position of system 300, and other Sensors 316, such as, for example, accelerometers, navigational processing system, internal control systems of the vehicle, etc., can provide data to other system components, such as processor 306.

In exemplary embodiments of the present invention, processor 306 can also send and receive both instructions and data to device interface 312, which can be, for example, a serial bus, a parallel bus, USB™, Firewire™, etc., that can, for example, communicate via known protocols to internal and external devices. Device interface 312 can be configured to send and receive information from mobile terminal 302. For example, processor 306 can transmit a GPS based vehicle location to mobile terminal 302 for security purposes.

Exemplary CLA 300 can also communicate with other wireless communication services (e.g., 3GPP, 802.11(n) wireless networks, Bluetooth™, etc.) via transceiver 307. For example, transceiver 307 can communicate with mobile terminal 302 via an ad-hoc Bluetooth™ network. Alternatively, for example, transceiver 307 can be connected to device interface 312. As noted above, processor 306 can employ a TCU application to operate in conjunction with transceiver 307, GPS receiver 314, Sensors 316 as well as other devices to implement various telematics and telematics related processes, as described herein.

In exemplary embodiments of the present invention, CLA 300 can optionally include a SDARS or other programming receiver 320 to receive either an SDARS broadcast stream or other content stream(s). Such received content streams can then be frequency modulated and retransmitted via FM transmitter 322 to head unit 304, as described above, or provided via a Bluetooth™ link or other interface. CLA 300 can also include DC converter 324 for receiving a DC voltage from vehicle power 326 and convert the received DC to a suitable DC voltage for use by CLA 300, as well as mobile terminal 302 or other devices. As described above, FM transmitter 322 can provide an FM audio stream to head unit 304 via the DC power line associated with vehicle power 326. Finally, CLA 300 can be provided with a microphone 318, via which a user can issue voice commands as well as communicate through the various provided communications links, e.g., cellular.

In the example of FIG. 3, CLA 300 does not need mobile terminal 302 to perform the above described functionalities. However, in other examples, where CLA 300 need not include certain components, it can then instead use mobile terminal 302 to perform some or all functionalities. For example, CLA 300 may not have capability to transmit to a cellular network (e.g., 3GPP, CDMA, etc.). In such cases CLA 300 can, for example, invoke a communications application on mobile terminal 302, provide the application with any pertinent data, and cause the application to transmit the data from mobile terminal 302.

As noted, device 300 can have its own three button user interface, with, for example, buttons for each of (i) phone—to make regular telephone calls through the automobile's speakers, (ii) agent—to contact a telematics service provider agent, and (iii) emergency—for contacting 911 or similar emergency responder dispatchers. It is noted that the buttons that correspond to emergency dialing, agent assistance, and hands-free functionality are preferably operational, even when the vehicle's ignition is off.

In addition, in some exemplary embodiments, a portable device can have an embedded or connected speaker, and a volume control, to facilitate interaction with the cellular modem, as shown in stand alone portable device embodiments such as that illustrated in FIG. 2A.

A primary use for an exemplary portable telematics device can be crash notification and emergency dialing, so the overall design of the device and the associated cables can, for example, be optimized for this use case. A HMI (Human Machine Interface) for the product can be simple, consisting of as few buttons as possible to achieve necessary functionality, as described above in connection with FIG. 2A. In exemplary embodiments of the present invention emergency dialing, agent assistance, hands free functionality, and volume control can be included and made accessible to a driver.

Use Cases

Next described are various use cases illustrating the utility as well as versatility of a portable telematics device, in one or more of the exemplary embodiments described above. The use cases address functionalities available even on a stand alone portable device, such as that depicted in FIG. 2A, and of course can be implemented as well using a more complex tethered mobile terminal system, such as shown in FIGS. 2B-2D.

Use Case 1—Automatic Crash Notification

When a vehicle encounters a collision, sensors and electronics in the CLA can, for example, detect the incident and automatically gather information (e.g., device identification number, covered vehicle GPS coordinates, call type, and other available data) from the CLA or vehicle bus and output this information, via an embedded cellular connection to an Emergency Response Center. An Emergency Response Center agent can then validate the subscriber's status, merge this information with other subscriber and vehicle data, and attempt to open a dialog with the vehicle to determine casualty condition and contact an appropriate emergency responder, such as the relevant Public Safety Answering Point (“PSAP”), for appropriate deployment of emergency service. If the Emergency Response Center agent is unable to establish verbal communication with the vehicle occupant(s), the agent can then deploy emergency services to the vehicle based upon the last known GPS coordinates. When contacting the PSAP, police or another emergency response provider, the Emergency Response Center agent can, for example, provide them with the covered vehicle and/or subscriber information (e.g., vehicle position, direction, color, cellular phone number), to the extent provided by the Crusader1 and the telematics service database. Should the vehicle lose power during the crash, a rechargeable back-up battery can ensure that all available data is sent to the agent. Such a backup battery can be, for example, a 3 Volt small footprint battery.

Use Case 2—Emergency Dialing/Crisis Assist

When a driver encounters an emergency and presses an emergency button on the portable device, an agent can be available to assist with (i) collecting any critical information related to the emergency and (ii) contacting the correct emergency service provider based upon the vehicle's location. The agent can remain on the line until the driver and vehicle receive assistance. In the event that the driver has witnessed an emergency, the incident can be reported to the agent, and the agent can relay the information to the appropriate authorities for assistance.

When a user presses the emergency button on the portable device, it can, for example, connect to an Emergency Response Center. The device can automatically gather information (e.g. device identification number, covered vehicle GPS coordinates, call type and other available data) from the vehicle bus and output this information via an embedded cellular connection through a telematics service database to the Emergency Response Center. Details on emergency response centers are provided in the PCT/US2012/068318 application which was cited above and incorporated herein by reference. An Emergency Response Center agent can validate the subscriber's status, merge this information with other subscriber data, and attempt to speak to the driver to understand the emergency situation. If the agent cannot speak with the driver, the agent can ask the occupant(s) to honk the horn, tap the steering wheel or console, or generally “make some type of noise” so that the agent knows that the occupants(s) are in the vehicle. If the foregoing attempts are unsuccessful in establishing some type of contact with the vehicle occupant(s) then the following procedure can, for example, be used: (i) If the location of the vehicle was received, the agent will pass an “unconfirmed” emergency to the PSAP; and (ii) If the location of the vehicle was not received, the agent will stay on the line with the vehicle for additional time and continue to query for some type of response and if unsuccessful will disconnect the call and note the service request accordingly.

Additionally, the portable device and/or tethered smartphone can be connected to a medical condition sensor, or other occupant condition sensor, to receive an output from the occupant condition sensor when a selected parameter falls outside a designated range or above or below a designated value, such as is defined using the subscriber portal, for example, and automatically initiate communication with a response provider.

As noted above, when contacting a PSAP, police or another emergency response provider, the Emergency Response Center agent can provide them with the covered vehicle and/or subscriber information (e.g., vehicle position, direction, registration plate and color, cellular phone number), to the extent provided by the portable telematics device (e.g., device 110 or 220 in FIG. 1 or 2A-2D, respectively) and the telematics service database. The Emergency Response Center will have the ability to terminate the call with a portable device according to a mutually agreed upon communications protocol.

Use Case 3—Roadside Assistance

Roadside assistance can, for example, include events such as a flat tire, dead battery, keys locked in the vehicle, no fuel, and tow truck assistance. When a user presses the Agent button on the keypad of the portable device, an operator can be available to direct assistance to the vehicle's location. In addition, the Agent can provide information regarding the location of nearest service facility, and can, for example, even contact that facility to schedule an appointment.

In exemplary embodiments of the present invention, a roadside assistance feature can also be enabled when a user engages the roadside assistance service via the vehicle's voice menu feature, or remotely through a cell phone or smart phone app. This call can be taken by an Interactive Voice Response (IVR) system that can, for example, route the call to a roadside assistance company. The subscriber can request assistance to connect to the appropriate authority for advice and/or to request assistance or repair service. At the subscriber's request, a roadside assistance provider can connect the user to a client-authorized service center. The telematics service database will provide all necessary data (e.g., device identification number, covered vehicle GPS coordinates, call type and other available data) from the portable device to the roadside assistance company.

Use Case 4—Smart Phone Notifications

In exemplary embodiments of the present invention, the following alerts/notifications can, for example, be sent from a portable device to a mobile telephone:

Crash Alert—this notification can be automatically generated when a vehicle sensors register that a crash has occurred. This notification can be posted to a Subscriber Portal And Mobile Application in addition to a Public Safety Answering Point (“PSAP”) (the functioning of a PSAP and the interaction of a telematics device with a PSAP are described in detail in PCT/US2012/068318. Communication to the subscriber of this vehicle condition can be, for example, via text, SMS message, or email, as may be determined by the subscriber preference input via the Subscriber Portal. This alert can, for example, be sent to up to five destinations that have been pre-determined by the vehicle owner.

Remote Alarm Notification—once enabled by a subscriber, a client authorized service center can support an alarm notification feature which causes a notification to be sent to the vehicle owner communicating that their covered vehicle's alarm system has been triggered. This notification can be posted to the Subscriber Portal and Mobile Application. Communication to the subscriber of this vehicle condition can be via text, SMS message, or email, as determined by the subscriber preference input via the Subscriber Portal. This alert can be sent up to five destinations that have been pre-determined by the vehicle owner.

Speed Alert—this service allows a subscriber to monitor a covered vehicle when it exceeds speed limits set by a subscriber. Subscribers can, for example, specify speed limits via the mobile application or the subscriber portal. This limit can be transmitted to the portable device, which can than monitor the vehicle's speed, via, for example, information from one or more of the vehicle bus or integrated sensor. When the vehicle's speed exceeds the set limit for more than a defined time interval, for example 10 seconds, the portable device can send a message to the client authorized service center, which can then notify the subscriber via the subscriber's preferred communication link. The subscriber can also set preferences via the Subscriber Portal so that the vehicle displays a speed alert notification to the driver.

Geo-fencing—This service that allows a subscriber to set geographic parameters for a covered vehicles usage, such as, for example, a designated geographic area or co-ordinates defining one or more geographic areas. If the vehicle is driven outside those constraints, and remains outside of those constraints for a period of a defined time interval, say, for example, more than 60 seconds, the subscriber can be notified. In exemplary embodiments of the present invention, subscribers can activate this feature, and specify the geographic driving range limit, via the Subscriber Portal or Mobile Application. These limits can, for example, be transmitted to the portable device, which can than monitor the vehicle's location. When the vehicle is operated inside an exclusion (non-permitted) zone or outside an inclusion (permitted) zone, a message can be sent to the operations center which will notify the subscriber of the violation via the subscriber's designated communication link. The subscriber can also set a preference to turn on or off a geo-fencing notification alarm or pop up to be received in the vehicle.

Valet Alert—Valet Alert is a subset of the geo-fencing service, where geo-fencing can be armed quickly by a driver, so that an alert can be generated if the covered vehicle is moved outside of a short distance from its present location once armed. This is useful when parking a car via a valet service at an event, affair or restaurant, for example, so as to ensure that the parking attendants do not “joy ride” with the vehicle. The range of distance before an alert is triggered can be dependent upon the condition preferences set at the Subscriber Portal or Mobile Application. If a vehicle is driven outside the set area, a subscriber can be notified, for example, via email and/or SMS.

Tow Alert—this notification can be triggered if the vehicle sensors register vehicle tilt. To register a vehicle lift event, the portable device can use an XYZ accelerometer, for example, to detect a change in orientation of the plane of the vehicle. For example, a threshold can be set for, for example, a 3 degree lift angle, and any angular change in orientation meeting or exceeding that threshold is interpreted as a vehicle lift.

Impact while Parked Alert—If the vehicle is parked and an impact occurs, the portable device's sensor can automatically send data to notify an agent of the occurrence. In addition, a crash alert notification can be sent to the destinations set by the subscriber via the Subscriber Portal or Mobile Application/recipients.

Low Battery Alert—as noted above, a re-chargeable back-up battery can be included in the portable device so that an emergency call can be made if the vehicle loses power during a collision. When the re-chargeable back-up battery in the device is running low and requires replacement, an indication can be communicated via the subscriber portal and mobile application. In addition, the portable device can give an audible and visible indication. Once this notification is received, the end user can receive information regarding battery replacement via the mobile application, subscriber portal, or directly from an agent.

Use Case 5—Hands-Free Calling

In exemplary embodiments of the present invention, Bluetooth capability built in to the portable device can allow a driver to pair his mobile device so that at the touch of the Phone Button, communication can occur via a speaker provided on the portable device. To use this feature a user would initiate the call from his mobile device. A volume control dial on the portable device allows a user to adjust the volume level during a call.

In exemplary embodiments of the present invention, a portable device's Bluetooth system can accept pairing from up to five mobile devices that also have Bluetooth capability. Only one paired device can be connected at a time. If multiple paired mobile devices are within range, the portable device can, for example, connect to devices in the order that they were paired. To pair a device, a user can press and hold the phone button on the device for a given number of seconds, for example. The phone button can, for example, flash blue or give some other indication. Following the prompts on the mobile device, a PIN and a device can be entered. Once the connection is made, the phone button will no longer flash, but can, for example, remain solid blue. An audible alert can also signal that successful paring has occurred. This process can be repeated to pair additional devices. If a connection is desired with another paired device, the phone button can again be pressed and held for a defined time interval for the next device in queue to be connected.

Alternatively, the portable device can support voice-activated hands-free calling with a prepaid minutes' package. For this option, a user must purchase minutes, which can be done directly from the vehicle by pressing the Agent button or by pressing the Phone button. If the latter option is used, a series of voice prompts can, for example, guide the user through purchasing minutes. In one example, in the event that minutes are used up during a call, the call will be terminated. This will trigger an immediate connection with an Agent so that minutes can be quickly added.

Alternatively, an “over minute protection” arrangement can be arranged, where a certain average of minutes is allowed and automatically arranged. In exemplary embodiments of the present invention, outgoing calls placed, and incoming calls received, can be deducted from a prepaid minutes balance. Emergency calls and Agent assistance calls would not count against the minutes balance.

To check the balance of minutes, a user can press the Phone button and a series of voice prompts can guide the user through acquiring this information. Minutes balance can also be accessed via the Subscriber Portal.

Use Case 6—Stolen Vehicle Location

In exemplary embodiments of the present invention, when a vehicle tracking request is received from a subscriber, a telematics service provider or other agent can, for example, confirm the location of the vehicle and provide the location to the police to assist their recovery of the lost vehicle. The service provider's operations center can request that the subscriber contact their local police department to obtain a police report. Once this report is obtained the subscriber can provide it to the service provider. The service provider's operations center can have the ability (provided the device and vehicle connections have been provisioned by the device designer to allow such command and control) to control the vehicle immobilizer function to incapacitate the engine from further restarting in a remote manner and within the guidelines of state law and in agreement with local police authorities. During the entire time the service is active, service provider can use reasonable efforts to attempt to block all other services via remote voice call, subscriber portal, and smart phone application and a notification of this state can be displayed on the Subscriber Portal and mobile app. A notification of feature activation can be sent to the customer using their preference settings (email, text, etc.). As remote access and functionality is subject to differing state laws and liability, deployment of these features can be determined by the Telematics Service Provider. Police can contact the subscriber to inform that the vehicle has been located and/or recovered. In exemplary embodiments, a Telematics Service Provider will not disclose the vehicle location data to the subscriber.

The components of the illustrative devices, systems and methods employed in accordance with the illustrated embodiments of the present invention can be implemented, at least in part, in digital electronic circuitry, analog electronic circuitry, or in computer hardware, firmware, software, or in combinations of them. These components can be implemented, for example, as a computer program product such as a computer program, program code or computer instructions tangibly embodied in an information carrier, in a machine-readable storage device or in a propagated signal, for execution by, or to control the operation of, data processing apparatus such as a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with various exemplary embodiments of the present invention can be performed, for example, by one or more programmable processors executing a computer program, code or instructions to perform functions (e.g., by operating on input data and/or generating an output). Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed:

1. A portable telematics device, comprising:
at least one sensor for detecting one or more conditions of a vehicle and/or its occupant(s);
a communications interface;
an antenna;
a user interface,
circuitry arranged to process signals from the at least one sensor and a GPS device to obtain a position of the vehicle and/or its occupants and to facilitate telephonic communications; and
at least one of a power source and a cigarette lighter adapter.

2. The telematics device of claim 1, wherein said at least one sensor includes one or more of an accelerometer, a 3-axis accelerometer, a 2-axis accelerometer, an accelerometer of range greater than 15 G, an accelerometer capable of measuring G forces up to a range of 15 G or higher, an accelerometer capable of measuring G forces up to a range of 25 G or higher, a vehicle rollover detector, an air bag deployment sensor, a spot locator, a personal safety or monitoring device, and a driver monitoring device.

3. The telematics device of claim 2, wherein additional sensors are located remotely from, and communicably connected to the device.

4. The telematics device of claim 1, wherein said communications interface is arranged to communicate with one or more of a remote monitoring system and a responder in response to one or more defined detected conditions.

5. The telematics device of claim 1, further comprising a USB charger.

6. The telematics device of claim 1, wherein said user interface includes a microphone and speaker, and a panic or emergency button, a phone button and an agent button.

7. The telematics device of claim 1, wherein the antenna is arranged to receive at least GPS signals and to transceiver cellular communications data.

8. The telematics device of any of claim 1, wherein the device is configured to fit inside a cigarette lighter adapter, and is plugged into said adapter.

9. The telematics device of claim 8, further comprising a backup battery to provide power for the device to operate when vehicle power fails or is disconnected from the device.

10. The telematics device of claim 4, wherein said conditions include at least one of a vehicle crash and an occupant's medical emergency.

11. The telematics device of claim 1, wherein said communications interface is arranged to communicate with one or more of a remote monitoring system and persons designated by a user in response to one or more defined detected conditions selected from the group consisting of: a vehicle lift, an impact sustained to the vehicle when stationary, the vehicle leaving an area defined by a geo-fence, and the vehicle exceeding a defined speed for a defined time period.

12. The telematics device of claim 1, wherein said GPS device is one of integrated in the portable device and communicably connected to the portable device.

13. A portable telematics device, comprising:
at least one sensor for detecting one or more conditions of a vehicle and/or its occupant(s);
a microprocessor;
an antenna;
at least one communications link to a mobile terminal; and
at least one of a power source and a cigarette lighter adapter.

14. The telematics device of claim 13, wherein the device is configured to perform at least one of (i) obtain position sensing information from the mobile terminal, (ii) obtain position sensing information from a connected GPS device, and (iii) perform position sensing with an integrated GPS device.

15. The telematics device of claim 13, wherein said at least one communications link includes one or more of a Bluetooth link, a wireless link, an ad hoc wireless link, and a USB cable connection.

16. The telematics device of claim 13, wherein said at least one sensor includes one or more of an accelerometer, a 3-axis accelerometer, a 2-axis accelerometer, an accelerometer of range greater than 15 G, an accelerometer capable of measuring G forces up to a range of 15 G or higher, an accelerometer capable of measuring G forces up to a range of 25 G or higher, a vehicle rollover detector, an air bag deployment sensor, a spot locator, a personal safety or monitoring device, and a driver monitoring device.

17. The telematics device of claim 16, wherein additional sensors are located remotely from, and communicably connected to the device.

18. The telematics device of claim 13, wherein in operation a user interacts with the device via the mobile terminal.

19. The telematics device of claim 13, further comprising one or more of a USB charger and a phone modem.

20. The telematics device of claim 13, wherein said mobile terminal is provided with a telematics application that receives data from the device, and said mobile terminal is arranged to communicate with one or more of a remote monitoring system and a responder in response to one or more defined detected conditions.

21. The telematics device of claim 13, wherein said device further comprises at least one of: (i) a microphone and speaker, (ii) a panic or emergency button, (iii) a phone button and (iv) an agent button.

22. The telematics device of claim 13, wherein the antenna is arranged to receive at least GPS signals.

23. The telematics device of any of claim 13, wherein the device is configured to fit inside a cigarette lighter adapter, and is plugged into said adapter.

24. The telematics device of claim 13, further comprising a backup battery to provide power to the device to operate when vehicle power fails or is disconnected from the device.

25. The telematics device of claim 20, wherein said conditions include at least one of a vehicle crash and an occupant's medical emergency.

26. The telematics device of claim 20, wherein said mobile terminal is arranged to communicate with one or more of a remote monitoring system, emergency responders and persons designated by a user, in response to one or more defined detected conditions selected from the group consisting of: a crash, a medical injury of a vehicle occupant, a vehicle lift, an impact sustained to the vehicle when stationary, the vehicle leaving an area defined by a geo-fence, the vehicle exceeding a defined speed for a defined time period.

27. The telematics device of claim 13, wherein said mobile terminal is communicably connected to a vehicle head unit.

28. The telematics device of claim 27, further comprising at least one of a wired and a wireless communications link from the device to the vehicle head unit.

29. The telematics device of claim 13, further comprising an SDARS receiver, and wherein said antenna is further arranged to receive SDARS signals.

30. The telematics device of claim 29, further comprising at least one of a wired and a wireless communications link from the device to the vehicle head unit, and wherein the device is arranged to communicate said SDARS audio content to said head unit.

31. The telematics device of claim 27, wherein said communicably connected includes one or more of a Bluetooth HFP link and a Bluetooth A2DP link.

32. The telematics device of claim 30, wherein audio content is sent from said mobile terminal to said vehicle head unit via a Bluetooth HFP link, and telephonic communications and telematics data from said portable device are sent from said mobile terminal to said vehicle head unit via a Bluetooth A2DP link.

33. The telematics device of claim 32, wherein both said Bluetooth HFP and said Bluetooth A2DP links can simultaneously operate, and wherein telephonic communications over said Bluetooth HFP link is prioritized.

34. The telematics device of claim 30, wherein said SDASRS audio content is sent over a wired link via FM modulation.

35. The telematics device of claim 2, wherein if said accelerometer is said 2-axis accelerometer, further comprising it having been aligned or calibrated based on its installation orientation in the device to measure lateral forces on the vehicle.

36. The telematics device of claim 16, wherein if said accelerometer is said 2-axis accelerometer, further comprising it having been aligned or calibrated based on its installation orientation in the device to measure lateral forces on the vehicle.
